(19) United States
(12) Patent Application Publication
(10) Pub. No.: US 2022/0055299 A1
(43) Pub. Date: Feb. 24, 2022

(54) PRINT HEAD FOR A PRINTING DEVICE FOR THE THREE-DIMENSIONAL APPLICATION OF A MATERIAL, PRINTING DEVICE AND METHOD

(71) Applicant: Siemens Aktiengesellschaft, 80333 München (DE)

(72) Inventors: JENS JÄHNICKE, Chemnitz (DE); CORNELIUS KÜHN, Erlangen (DE)

(73) Assignee: Siemens Aktiengesellschaft, 80333 München (DE)

(21) Appl. No.: 17/413,447

(22) PCT Filed: Oct. 30, 2019
(86) PCT No.: PCT/EP2019/079632

§ 371 Date: Jun. 11, 2021

(30) Foreign Application Priority Data
Dec. 12, 2018 (EP) 18212009.7

(51) Int. Cl. B29C 64/209; B29C 64/118; B29C 64/295; B29C 64/268

(52) U.S. Cl. CPC B29C 64/209; B29C 64/118; B33Y 30/00; B29C 64/268; B29C 64/295

(57) ABSTRACT

A print head for a printing device for the three-dimensional application of a material includes a heated nozzle configured to melt the material and to dispense the melted material in the form of a strand for application on a substrate or on a previously applied material strand which has at least partly solidified, as the print head moves along a predefined direction of travel. Provision is made for a melting facility which continuously applies heat locally to a region of the previously applied material strand during movement of the print head.

The present invention relates to a print head for a printing device for the three-dimensional application of a material. The print head comprises a heated nozzle for melting a material and for dispensing the melted material. The print head in this case is designed to apply the melted material in the form of a strand on a previously applied material, which has at least partly solidified, and/or on a substrate, as the print head moves along a predefined direction of travel. The present invention further relates to a printing device for the three-dimensional application of a material using such a print head, Finally, the present invention relates to a method for the three-dimensional application of a material.

Numerous additive manufacturing methods or three-dimensional printing methods are disclosed in the prior art. Of interest here is in particular the so-called FLM (fused layer manufacturing/modeling) method which, as a strand-extrusion method, is characterized in that melted plastic tracks are deposited one on top of the other. In this context, mechanical anisotropies occur in the component to be manufactured, primarily in the build-up direction, as a result of the manufacturing process. Said anisotropies are produced because the previously applied material or the immediately preceding printed track has already cooled down before a new track is melted thereon. This is manifested not only in a distortion of the component, but primarily in the reduced mechanical stability under load in a build-up direction. As a result of the high temperature gradients, the plastic tracks are not welded together completely and therefore the interlaminar adhesion can only be suboptimal. In some cases, this can cause a reduction of the mechanical properties by 40% to 60% in relation to the horizontal loading capacity. A boundary surface or weld seam would be ideal in which both layers are fused with no visible difference.

In the field of additive manufacturing, there are currently very few approaches which address the problem directly. In some cases, the distortion and the interlaminar adhesion are improved by heating the entire construction space in which both the print head and the previously applied material are located. As a result of heating the entire construction space, all mechanical parts are likewise exposed to the direct heat and this can cause failures in the case of motors or other electronic components. Only by means of a very expensive insulation design can additional parts be indirectly protected from the heat convection. Likewise, the decomposition reactions in the molecule chains of the polymers during the entire build-up process must not be underestimated. Although the adhesion and the distortion are generally improved by applying this principle, the performance characteristics of these are limited. Actual “welding” in the boundary layer cannot be realized thus.

In conventional manufacturing, so-called laser penetration welding is a further proven system for joining plastics. In this context, a transmitting and an absorbing plastic are combined, together forming the joining zone or a boundary surface. The transparent plastic in this case is penetrated by a laser beam without significant heating. The laser beam is only fully absorbed in the absorbing plastic in a layer close to the surface, the laser energy being converted into thermal energy and the plastic being melted thus.

The object of the present invention is to set forth a solution whereby, using a three-dimensional printing method of the type described in the introduction, the mechanical properties of the manufactured component can be improved.

This object is inventively achieved by a print head, a printing device and a method having the features according to the independent claims. Advantageous developments of the present invention are specified in the dependent claims.

An inventive print head for a printing device for the three-dimensional application of a material comprises a heated nozzle for melting the material and for dispensing the melted material. In this case, the print head is designed to apply, as the print head moves along a predefined direction of travel, the melted material in the form of a strand on a previously applied material, which has at least partly solidified, and/or on a substrate. Furthermore, the print head comprises a melting facility which is designed to continuously apply heat locally to respective regions of the previously applied material as the print head is moving.

The print head can be used in a printing device for the three-dimensional application of the material. In particular, the printing device can be used to perform the so-called FLM method. A component can be produced by means of the method. In this case, the material can be initially supplied to the nozzle in a solid state. The material can be a thermoplastic material in particular, e.g. a corresponding plastic. The material can be provided and supplied to the nozzle in the form of a filament, for example. Provision can also be made for the material to be supplied to the nozzle in the form of granules. The nozzle can have a corresponding heating facility by means of which the material can be heated and melted thus. The material can be transported within the nozzle, the melted material emerging at an opening of the nozzle. The melted material can therefore be dispensed by means of the nozzle. The nozzle can be moved relative to the substrate in this case. For example, the nozzle can be moved along two reciprocally perpendicular spatial directions. Provision can also be made for the nozzle to additionally be moved along a third spatial direction. Alternatively, the substrate or a height-adjustable table on which the substrate is arranged can be adjusted in the third spatial direction. In this case, the nozzle is moved along the direction of travel that was defined previously for the production of the component. In this context, the melted material is dispensed in the form of a strand or a track. These tracks are then arranged one above the other in the build-up direction. In this case, the melted material is usually applied onto the previously applied material or onto a previously applied track, the previously applied material being at least partly solidified or firm.

According to an essential aspect of the present invention, the print head also has the melting facility. In this case, the melting facility is designed to continuously apply heat locally to respective regions of the previously applied material as the print head is moving. By means of the melting facility, the previously applied material or the previously applied track, which has at least partly solidified, can be heated locally and consequently melted locally. The melting facility therefore differs from a heating facility of the nozzle which serves to melt the material within the nozzle or within the print head. Moreover, it is not intended in particular for all of the previously applied material or a construction space in which the previously applied material is located to be heated in its entirety by the melting facility. The melting facility is intended to locally melt individual regions of the previously solidified material. During operation of the printing device, the print head is moved continuously along the direction of travel. As the print head moves, the respective predefined regions can be heated or melted continuously or consecutively by means of the melting facility. As a result of this, e.g. the connection between the locally melted material and the melted material that is subsequently discharged from the nozzle is improved. The mechanical properties of the component can be improved thus.

In an embodiment variant, as the respective region of the previously applied material, the melting facility is designed to apply heat locally to a pre-heat region which is situated ahead of the nozzle in the direction of travel, before the application of the melted material. In other words, by means of the melting facility, pre-heating of the previously applied material can take place at precisely this region before the discharge of the melted material from the nozzle. Provision can therefore be made for the melting facility to have a pre-heating unit by means of which heat is applied to the region ahead of the nozzle in the direction of travel. For the purpose of producing the component from the material, the direction of travel is predetermined. Also known in particular is the position at which the nozzle will be situated at a particular time point. Therefore, when the nozzle is situated at a predefined position, the position to which it will next be moved is known. This position, to which the nozzle will next be moved, represents the region that will be locally heated and melted by means of the melting facility. In this case, the pre-heat region can have a width which corresponds to at least the width of the strand. The melted material can then be discharged from the nozzle onto this locally melted region. It is thus possible, after hardening has taken place, to achieve an improved mechanical connection between these two material layers or tracks. The mechanical anisotropy in the component can be reduced thereby. Improved mechanical properties of the component can be achieved. Most importantly, however, the mechanical properties of the component can be predicted more effectively. This allows more accurate dimensioning of the component, whereby expensive overdimensioning can be avoided.

In a further embodiment variant, after the application of the melted material, as the respective region, the melting facility is designed to apply heat to a boundary surface region at a boundary surface between the applied melted material and the previously applied material. Alternatively or in addition to the pre-heating as described above of the previously applied material, the boundary surface between the previously applied material and the melted material being applied at the time can also be thermally influenced by means of the melting facility. As described above, the previously applied material can be at least partly solidified or firm. Immediately after the application of the melted material from the nozzle, said melted material is still at least partly liquid. In this state, the melting facility can be used to apply heat to the previously applied material or the solidified material locally at the boundary surface to the melted material being applied at the time. In this way, the previously applied material can be melted locally at the boundary surface or in the boundary surface region. These two material tracks can therefore be connected together in a similar manner to penetration welding. By means of combining the penetration welding with the FLM method, it is possible to achieve a better overall process, as a result of which the mechanical anisotropy can be largely eliminated.

In this context, provision is made in particular for the melting facility to be designed to inject a radiation into the applied melted material in order to heat the boundary surface region, such that the radiation penetrates the melted material and is absorbed at the previously applied material. This radiation can preferably be provided by laser light source. A laser light source can therefore be integrated into the FLM method, the radiation of which optically penetrates the melted material being applied at the time and only penetrates into the boundary surface of the underlying track or the previously applied solidified material. This produces a heat effect zone in which the boundary layer surfaces are welded together by approximately identical temperatures. Thermal stresses can be reduced thereby. Reduced distortion in the component is also achieved as a result of supplying heat locally. In this case, the uppermost track or the melted applied material is penetrated optically first and then the coupling to the boundary surface takes place.

In this context, provision is made in particular for the uppermost track or the applied melted material to be permeable to the radiation in a specific temperature range and for a boundary surface to be present. This is possible, for example, if the radiation penetrates the directly extruded and therefore still hot material and then strikes the previously applied and cooled material. In this case, the melted or liquid material can have amorphous properties and the previously applied material or the solidified material can have (semi)crystalline properties.

The local heating as described above of the boundary surface clearly differs from conventional laser penetration welding. Laser penetration welding is normally used to join different plastics which are both already in the cooled state. In addition, use is not made of the temperature-dependent optical properties based on the phase transitions, but fundamentally of the different degrees of crystallization of the plastics to be joined (amorphous-semicrystalline). This results in the use of different plastics, namely a transmitting plastic and an absorbing plastic, hi the method according to the invention, one and the same plastic is used, which transmits or absorbs solely on the basis of its phase state and therefore as a function of the temperature.

In a further embodiment variant, the melting facility comprises alight source for emitting laser light and/or an optical element for guiding the laser light. The melting facility can comprise at least one light source by means of which the laser light can be emitted. This light source can be a laser, a laser diode or similar. In particular, high-energy radiation can be output by the light source, which can also be referred to as a radiation source. The light source can be arranged directly at the nozzle, for example. In addition, the melting facility can have an optical element, e.g. a lens, by means of which the laser light can be guided or concentrated. The arrangement of the optical element relative to the light source and/or the embodiment of the optical element allow e.g. the focus or a focal point of the laser radiation to be predetermined. Provision can also be made for the light source to be remote from the nozzle, in this case, the laser light which is emitted by the light source can be guided to a region of the nozzle via a light conductor, for example. This means that the laser light can be outcoupled at an outlet end of the light conductor, A corresponding optical element can be used in this case likewise. By means of the laser radiation or the laser light, the applied material can be heated locally or regionally. In this way, the print head can be improved with little effort and at little expense.

Provision can also be made for the melting facility to be designed to dispense a corresponding stream of hot gas for the purpose of locally heating the previously applied material. Using such a hot-gas nozzle, it is possible to dispense a corresponding protective gas or inert gas with a predefined temperature. Alternatively, provision can be made for the melting facility to have a corresponding plasma nozzle. A hot-gas nozzle or a plasma nozzle can be used in particular for the local melting of the pre-heat region.

In a further embodiment variant, the print head has an annular lens as the optical element, said annular lens surrounding the nozzle. In this context, provision is preferably made for this annular optical system or lens to be supplied with the radiation or the laser light via a corresponding light conductor. By virtue of this annular nozzle, it is possible to ensure that ail regions of the material around the nozzle can be melted. By means of the annular optical element, the focus of the laser light can be adjusted in such a way that it lies in a region of the boundary surface between the previously applied material and the melted material being discharged at the time, or on the surface of the previously applied material. By means of this annular optical system, it is possible to achieve both the pre-heating of the previously applied material and the fusing of the two material layers at the boundary layer. As a result of the region around the discharged extrusion stream being warmed by means of this optical system, both the pre-heating ahead of the nozzle in the direction of travel is realized, and the heating in the region of the boundary surface is realized behind the nozzle in the direction of travel. In addition to this, the use of the annular optical system has the advantage that the control is simplified. In this context, the pre-heating and heating of the boundary surface does not have to be adapted to the movement of the nozzle. The additional heating of the further regions, which are heated by the annular nozzle, does not have a negative effect on the material structure in this case.

In a further embodiment variant, the print head has a control facility for adjusting a heat energy that is provided by the melting facility for the purpose of applying heat locally to the region. In other words, it is possible by means of the control facility to adjust the thermal power that is provided by the melting facility. As explained above, the melting facility can have a light source or laser light source. In order to adapt the heat energy or thermal power, the intensity of the radiation can be adapted. It is consequently possible, for example, for the thermal energy provided by the melting facility to be adapted to the material in use.

According to a further embodiment variant, the print head comprises a detection facility for the purpose of continuously detecting a current temperature of the respective region. The detection facility can have a corresponding sensor, for example, by means of which the current temperature of the region to be heated by the melting facility can be detected. The detection facility can have a corresponding infrared sensor, for example. It is consequently possible by means of the detection facility to ascertain the respective temperatures of the melted material being dispensed at the time and/or of the previously applied and at least partly solidified material. The printing process can be monitored and optionally adapted on the basis of these detected temperatures.

According to a further embodiment variant, the control facility is designed to provide closed-loop control of the heat energy that is introduced by the melting facility as a function of the temperature detected by the detection facility. If pre-heating is to be performed by means of the melting facility, for example, the temperature of the previously applied material can be detected and the heat energy that is output by the melting facility for the pre-heating of this region can be adapted. This means that it is possible to ascertain, for example, the desired temperature that is to be achieved for the material to be pre-heated. Said desired temperature can be calculated or ascertained in corresponding trials beforehand. Provision can also be made for ascertaining the temperature of the currently applied and still melted material, in order to enable verification that material is permeable to the radiation. Heating of the boundary surface or fusing of the materials at the boundary surface can therefore be controlled effectively in an open-loop or closed-loop system.

According to an alternative embodiment variant, provision can be made for the melting facility to be mobile relative to the nozzle. In particular, the melting facility can be moved as a function of the predefined direction of travel or the intended path of travel of the nozzle. In the case of pre-heating, it is therefore possible correspondingly to heat those regions in which the melted material will be applied in the future. This applies likewise to the heating of the boundary surface between the already solidified material and the melted material being discharged at the time.

A printing device according to the invention for the three-dimensional application of a material comprises a print head according to the invention. The printing device can also have a corresponding drive by means of which the print head can be moved. Provision can also be made for the detection facility described above and/or the control facility described above to be part of the printing device.

A method according to the invention is used for the three-dimensional application of a material by means of a print head. In this context, the material is melted by means of a heated nozzle and the melted material is dispensed. In addition to this, the print head is moved along a predefined direction of travel. In this context, the melted material is applied in the form of a strand on a previously applied material, which has at least partly solidified, and/or a substrate. In this context, during the movement of the print head, provision is made for respective regions of the previously applied material to be continuously heated locally by means of a melting facility of the print head.

As described above in connection with the print head, it is possible to perform pre-heating before the application of the melted material, and/or heating of the boundary surface between the currently applied melted material and the already solidified underlying material. In particular, provision is made for the melting facility to have a laser light source by means of which the applied material can be heated or melted locally. In order to realize the heating of the boundary surface in particular, it is possible to use as a material a plastic which has amorphous properties in the melted state and (semi)crystalline properties in the solidified state. This plastic can be thermoplastic in particular. A natural boundary surface is produced between the solidified material and the melted material applied thereon. This natural boundary surface can be further influenced by the process temperature and process management. Alternatively or additionally, corresponding additives which improve the absorption of the laser radiation can be applied after the application of the melted material or after each layer, so that a laser-deep layer forms between the individual layers or tracks. The additives can take the form of a liquid, powder, aerosol, film or gas, for example. In addition to this, the focus of the laser beam can be adapted is such a way that the focus or a focal point lies in the region of the boundary surface. It is thereby possible to ensure that the application of energy only takes place in the boundary surface.

The embodiment variants described above in connection with the inventive print head, and the advantages thereof, apply correspondingly to the inventive printing device and to the inventive method.

Further features of the invention are derived from the claims, the figures and the description of the figures. The features and combinations of features cited above in the description and the features and combinations of features cited below in the description of the figures and/or shown in the figures alone can be used not only in the respectively specified combination but also in other combinations without departing from the scope of the invention.

The invention is explained in the following on the basis of preferred exemplary embodiments and with reference to the appended drawings, in which:

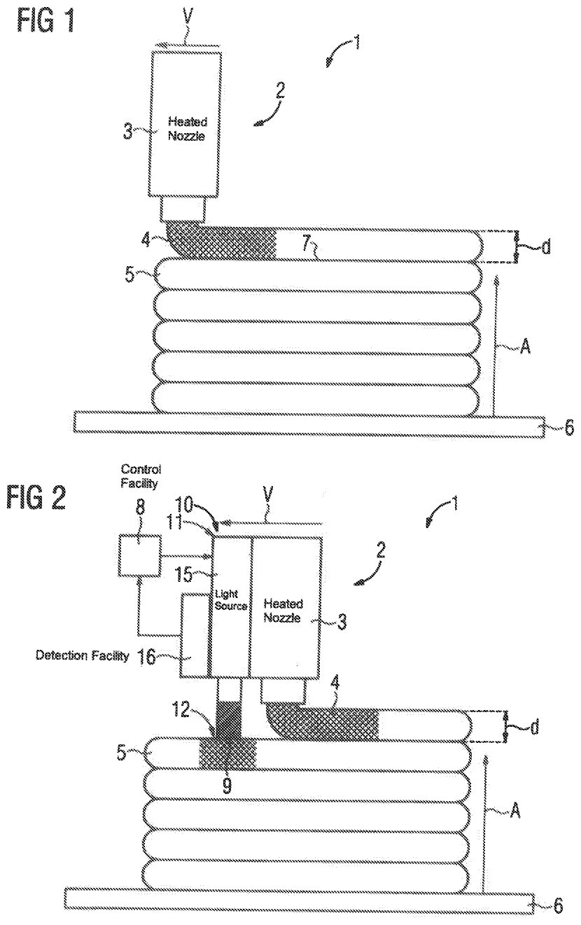

FIG. 1 shows a schematic illustration of a printing device for the three-dimensional application of a material in accordance with the prior art;

FIG. 2 shows a schematic illustration of a printing device with a print head according to a first embodiment variant;

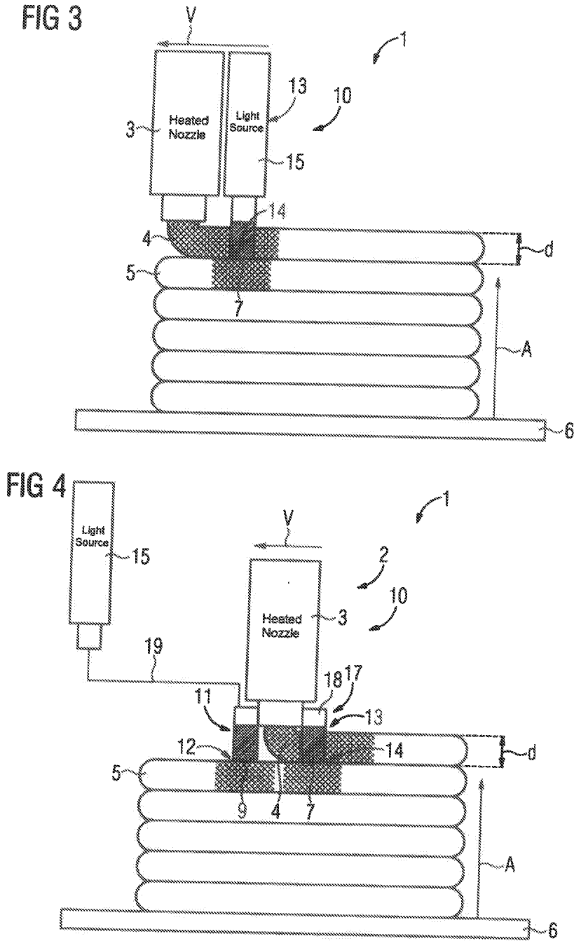

FIG. 3 shows a schematic illustration of a printing device with a print head according to a second embodiment variant; and

FIG. 4 shows a schematic illustration of a printing device with a print head according to a third embodiment variant.

Identical or functionally identical elements in the figures are denoted by the same reference signs.

FIG. 1 shows a schematic illustration of a printing device 1 according to the prior art. The so-called FLM method can be performed using this printing device 1. The printing device 1 comprises a print head 2 which has a heated nozzle 3. A material is supplied to said nozzle 3, e.g. in the form of a filament. Said material can be heated and melted by means of the nozzle 3, A melted material 4 can be dispensed by the nozzle 3 in this way. In this case, the melted material 4 is dispensed in the form of a strand or a track. In this case, the melted material 4 is applied on a previously applied material 5 which has at least partly solidified. At the beginning of the method, the material is applied on a substrate 6. Following thereupon, a plurality of layers or tracks are applied one above the other along a build-up direction A. The respective tracks have a thickness d, the thickness d of the respective tracks being identical. The print head 2 is moved along a direction of travel V by means of a drive which is not shown here.

The previously applied material 5 is at least partly solidified when the melted material 4 is applied thereon. The previously applied material 5 has a significantly lower temperature than the melted material 4. Owing to this temperature difference, mechanical stresses can occur between these two tracks. This can result in the occurrence of an unsatisfactory connection at a boundary layer 7 between the melted material 4 and the previously applied material 5 or between these tracks lying one above the other in the build-up direction A.

FIG. 2 shows a schematic illustration of a printing device 1 with a print head 2 according to a first embodiment variant. The print head 2 here has a heated nozzle 3 likewise. In addition to this, the print head 2 comprises a melting facility 10. The melting facility 10 is used to heat the previously applied material 5 locally or regionally. In the present example, the melting facility 10 comprises a pre-heating unit 11. The pre-heating unit 11 makes it possible to heat a pre-heat region 12 of the previously applied material 5, said pre-heat region 12 being situated ahead of the nozzle 3 in the direction of travel V. The melted material 4 is therefore next applied in this pre-heat region 12 by means of the nozzle 3. As a result of the local heating of the pre-heat region 12, the previously applied material 5, which has solidified, can be melted. The connection between the previously applied material 5 and the melted material 4 applied thereon can be improved thereby.

The melting facility 10 or the pre-heating unit 11 comprises a light source 15, by means of which laser radiation can be emitted. In this case, a surface 9 of the previously applied material 5 can be heated by means of the Eight source 15. In this context, a focus of the light source 15 can be adjusted such that it lies on the surface 9 of the previously applied material 5. The print head 2 further comprises a control facility 8, by means of which operation of the light source 15 can be adapted. For example, a radiation power of the laser radiation that is emitted by the light source 15 can be adjusted. Furthermore, the print head 2 comprises a detection facility 16, by means of which a current temperature of the previously applied material 5 can be ascertained. The light source 15 can be controlled by the control facility 8 as a function of the current temperature. In this way, it is possible to adapt the radiation power of the laser radiation to the current temperature and thereby to determine how the previously applied material 5 is heated. It is thus possible to ensure that the pre-heat region 12 is adjusted to a predefined desired temperature. In particular, a closed control loop can be provided thus in order to regulate the temperature of the pre-heat region 12 to the desired temperature. The control facility 8 and the detection facility 16 here are part of the print head 2 and are arranged at the nozzle 3. Provision can also be made for the control facility 8 and/or the detection facility 16 to be arranged remotely from the nozzle 3 and/or to be part of the printing device 1.

FIG. 3 shows a schematic illustration of a printing device 1 with a print head 2 according to a second embodiment variant. Here likewise, the print head 2 has the heated nozzle 3. Furthermore, the print head 2 has a melting facility 10 which has a penetration unit 13 in this example, A boundary surface region 14 can be heated by means of the penetration unit 13. This boundary surface region 14 is the boundary surface 7 between the previously applied material 5 and the currently applied melted material 4. Furthermore, the boundary surface region 14 is arranged behind the nozzle 3 in the direction of travel V. The penetration unit 13 also comprises a light source 15, by means of which laser radiation can be emitted. In this context, the focus is adjusted onto the boundary surface 7. By means of the penetration unit 13, the boundary surface region 14 can be heated directly after the application of the melted material 4.

The material can be a thermoplastic plastic. In the melted state, this material can be permeable to the radiation of the light source. In the melted state, the material can have amorphous properties. The previously applied material 5, which has at least partly solidified, can have semicrystalline or crystalline properties and absorb the radiation. It is therefore possible to achieve heating of the boundary surface region 14. In the pre-heat region 12, the radiation directly strikes the surface 9 of the previously applied material 5. This means that the connection between these two layers can be improved and quasi-welding of the layers can be achieved. This print head 2 likewise can have the control facility 8 and/or the detection facility 16.

FIG. 4 shows a schematic illustration of a printing device 1 with a print head 2 according to a third embodiment variant. This print head 2 likewise has the heated nozzle 3. The print head 2 also has the melting facility 10. In this case, the melting facility 10 comprises an optical element 17 in the form of an annular lens 18, said annular lens 18 surrounding the nozzle 3. The melting facility 10 further comprises the light source 15, which is arranged remotely from the nozzle 3. In this case, the light or the radiation from the light source 15 is guided via a light conductor 19 to the optical element 17. By means of the optical element 17 or the annular lens 18, both the pre-heating unit 11 and the penetration unit 13 are realized. By means of the annular lens 18, the whole region around the nozzle 3 is heated. In this case, the pre-heat region 12 is heated ahead of the nozzle 3 in the direction of travel V, and the boundary surface region 14 is heated behind the nozzle 3 in the direction of travel V.

In this case, the focus of the optical element 17 or the annular lens 18 is so selected as to lie on the boundary surface 7. The focus therefore also lies on the surface 9 of the previously applied material 5, since the surface 9 has the same height as the boundary surface 7 in the build-up direction A. It is possible by means of the optical element 17 to heat or melt both the pre-heat region 12 and the boundary surface region 14, irrespective of the direction of travel V. This print head 2 likewise can have the control facility 8 and/or the detection facility 16.

What is claimed is:

1-11. (canceled)

12. A print head for a printing device for the three-dimensional application of a material, said print head comprising:
a heated nozzle configured to melt the material and to dispense the melted material in the form of a strand for application on a substrate or on a previously applied material strand which has at least partly solidified, as the print head moves along a predefined direction of travel; and
a melting facility configured to continuously apply heat locally to a region of the previously applied material strand during movement of the print head.

13. The print head of claim 12, wherein the melting facility includes a pre-heat unit disposed anteriorly of the nozzle to heat the region of the previously applied material strand as a pre-heat region situated ahead of the nozzle in the direction of travel, before application of the melted material.

14. The print head of claim 12, wherein the melting facility includes a radiation penetration unit disposed posteriorly of the nozzle to apply heat to a boundary surface region at a boundary surface between the applied melted material and the previously applied material strand, after the application of the melted material.

15. The print head of claim 14, wherein the radiation penetration unit of the melting facility is designed to inject a radiation into the applied melted material so as to heat the boundary surface region, such that the radiation penetrates the melted material and is absorbed at the previously applied material.

16. The print head of claim 12, wherein the melting facility includes a light source for emitting laser light.

17. The print head of claim 12, wherein the melting facility includes a light source for emitting laser light and an optical element for guiding the laser light.

18. The print head of claim 17, wherein the optical element is an annular lens disposed in surrounding relation to the nozzle.

19. The print head of claim 12, further comprising a control facility operably connected to the melting facility and designed to adjust a heat energy of the heat provided by the melting facility so as to apply heat locally to the region.

20. The print head of claim 12, further comprising a detection facility configured to continuously detect a current temperature of the region.

21. The print head of claim 19, wherein the control facility is designed to provide a closed-loop control of the heat energy that is introduced by the melting facility as a function of the temperature detected by the detection facility.

22. A printing device for the three-dimensional application of a material, said printing device comprising a print head, said print head comprising a heated nozzle configured to melt the material and to dispense the melted material in the form of a strand for application on a substrate or on a previously applied material strand which has at least partly solidified, as the print head moves along a predefined direction of travel, and a melting facility configured to continuously apply heat locally to a region of the previously applied material strand during movement of the print head.

23. The printing device of claim 22, wherein the melting facility includes a pre-heat unit disposed anteriorly of the nozzle to heat the region of the previously applied material strand as a pre-heat region situated ahead of the nozzle in the direction of travel, before application of the melted material.

24. The printing device of claim 22, wherein the melting facility includes a radiation penetration unit disposed posteriorly of the nozzle to apply heat to a boundary surface region at a boundary surface between the applied melted material and the previously applied material strand, after the application of the melted material.

25. The printing device of claim 24, wherein the radiation penetration unit of the melting facility to inject a radiation into the applied melted material so as to heat the boundary surface region, such that the radiation penetrates the melted material and is absorbed at the previously applied material.

26. The printing device of claim 22, wherein the melting facility includes a light source for emitting laser light and/or an optical element for guiding the laser light.

27. The printing device of claim 26, wherein the optical element is an annular lens disposed in surrounding relation to the nozzle.

28. The printing device of claim 22, wherein the print head includes a control facility operably connected to the melting facility and designed to adjust a heat energy of the heat provided by the melting facility so as to apply heat locally to the region.

29. The printing device of claim 22, wherein the print head incudes a detection facility configured to continuously detect a current temperature of the region.

30. The printing device of claim 28, wherein the control facility is designed to provide a closed-loop control of the heat energy that is introduced by the melting facility as a function of the temperature detected by the detection facility.

31. A method for the three-dimensional application of a material by a print head, said method comprising:
melting and dispensing the material by a heated nozzle in the form of a strand for application on a substrate or on a previously applied material strand which has at least partly solidified, as the print head moves along a predefined direction of travel; and
during movement of the print head, continuously heating a region of the previously applied material locally by a melting facility of the print head.
